(19) United States
(12) Patent Application Publication
(10) Pub. No.: US 2025/0233397 A1
(43) Pub. Date: Jul. 17, 2025

(54) CONDUCTOR

(71) Applicant: Yazaki Corporation, Tokyo (JP)

(72) Inventors: Tomohiro Urashima, Tochigi (JP); Hiroyasu Furuya, Tochigi (JP); Genki Furuya, Tochigi (JP); Kohki Nakamura, Tochigi (JP)

(21) Appl. No.: 18/984,225

(22) Filed: Dec. 17, 2024

(30) Foreign Application Priority Data
Jan. 17, 2024 (JP) 2024-005337

(51) Int. Cl. H02G 5/02

(52) U.S. Cl. CPC H02G 5/025

(57) ABSTRACT

A conductor includes a pair of bus bars, and an exterior component attached to the pair of bus bars. Each of the pair of bus bars includes a conductor portion and an insulating sheath with which the conductor portion is covered, and at least partially includes an attached portion extending in a linear shape. The exterior component includes a pair of groove portions extending in a linear shape so as to be capable of accommodating the attached portions of the pair of bus bars and opening in mutually different directions, and a pair of cover portions capable of opening and closing opening portions of the pair of groove portions.

### CROSS-REFERENCE TO RELATED APPLICATIONS

This application is based on and claims priority under 35 USC 119 from Japanese Patent Application No. 2024-005337 filed on Jan. 17, 2024, the entire content of which is incorporated herein by reference.

### TECHNICAL FIELD

The present disclosure relates to a conductor including a pair of bus bars and an exterior component attached to the pair of bus bars.

### BACKGROUND ART

In the related art, when routing a metal bus bar in an automobile or the like, it has been proposed to assemble an insulating exterior component so as to cover the bus bar and, if necessary, to fix the exterior component to a vehicle body or the like of the automobile or the like as disclosed in, for example, JP2018-190532A.

The above type of bus bar generally has a shape extending along a predetermined routing path (so-called a layout) according to the specifications of the automobile or the like. Similarly, the exterior component generally has a shape corresponding to the routing path so that such a bus bar can be accommodated. In other words, the exterior component has a dedicated shape that differs for each specification of the bus bar. Therefore, as a matter of course, if the shape of the bus bar is different, the shape of the exterior component is also different. On the contrary, if the exterior component is generalized, a degree of design freedom in the shape of the bus bar decreases. For this reason, it is generally difficult to achieve both improvement of the degree of design freedom in the shape of the bus bar and improvement of versatility of the exterior component.

The present disclosure provides a conductor capable of achieving both improvement of a degree of design freedom in shapes of bus bars and improvement of versatility of an exterior component.

In order to achieve the above object, the conductor according to the present disclosure is characterized as follows.

### SUMMARY

According to the present disclosure, a conductor includes a pair of bus bars, and an exterior component attached to the pair of bus bars. Each of the pair of bus bars includes a conductor portion and an insulating sheath with which the conductor portion is covered, and at least partially includes an attached portion extending in a linear shape. The exterior component includes a pair of groove portions extending in a linear shape so as to be capable of accommodating the attached portions of the pair of bus bars and opening in mutually different directions, and a pair of cover portions capable of opening and closing opening portions of the pair of groove portions.

According to the conductor of the present disclosure, each of the pair of bus bars includes the conductor portion covered with the insulating sheath, and at least partially includes the attached portion extending in a linear shape. The attached portion is used to attach the bus bars and the exterior component. Specifically, the attached portions of the pair of bus bars are accommodated in the pair of groove portions of the exterior component, respectively. In this way, the conductor portion of the bus bar is covered with the insulating sheath, and thus it is not necessary to provide the exterior component so as to cover the entire bus bars. Further, the exterior component only needs to have the groove portions capable of accommodating the attached portions in a linear shape and the cover portions for opening and closing the groove portions, and does not need to have a dedicated shape for each bus bar. Accordingly, versatility of the exterior component can be improved. On the other hand, in the bus bar, a shape of a location other than the attached portions can be designed without considering the presence of the exterior component. Accordingly, a degree of design freedom in the shapes of the bus bars can be improved. Therefore, the conductor of the present configuration can achieve both the improvement of the degree of design freedom in the shapes of the bus bars and the improvement of the versatility of the exterior component.

Further, as another effect, the pair of groove portions of the exterior component open in mutually different directions, and thus when the bus bars are detached from the exterior component, one of the bus bars is prevented from coming into contact with the other of the bus bars, thereby preventing an unintended short circuit between the bus bars. Further, it is possible to reduce a size of the exterior component or to improve a workability of a work of attaching the exterior component to the bus bar.

The present disclosure is briefly described above. Further, details of the present disclosure will be clarified by reading modes for carrying out the disclosure to be described below with reference to the accompanying drawings.

### BRIEF DESCRIPTION OF DRAWINGS

FIG. 1 is a perspective view showing an assembled state of a conductor according to an embodiment of the present disclosure;

FIG. 2 is a perspective view showing a state in which both a first bus bar and a second bus bar are separated from an exterior component in the conductor shown in FIG. 1;

FIG. 3 is a top view of the conductor shown in FIG. 1;

FIG. 4 is a bottom view of the conductor shown in FIG. 1;

FIG. 5 is a front view of the conductor shown in FIG. 1;

FIG. 6 is a front view of the conductor shown in FIG. 2;

FIG. 7 is a view corresponding to FIG. 6 in a modification;

FIG. 8 is a view corresponding to FIG. 3 in the modification shown in FIG. 7; and

FIG. 9 is a view corresponding to FIG. 4 in the modification shown in FIG. 7.

### DESCRIPTION OF EMBODIMENTS

### Embodiment

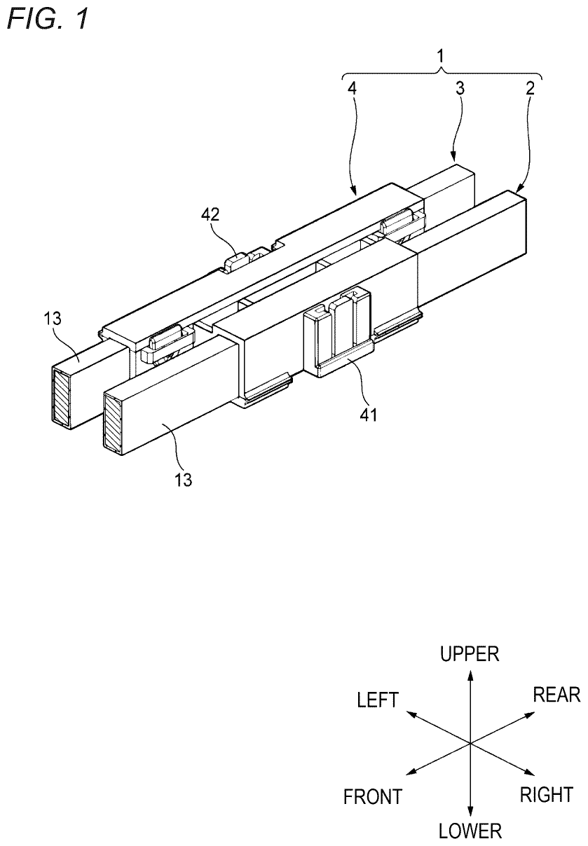

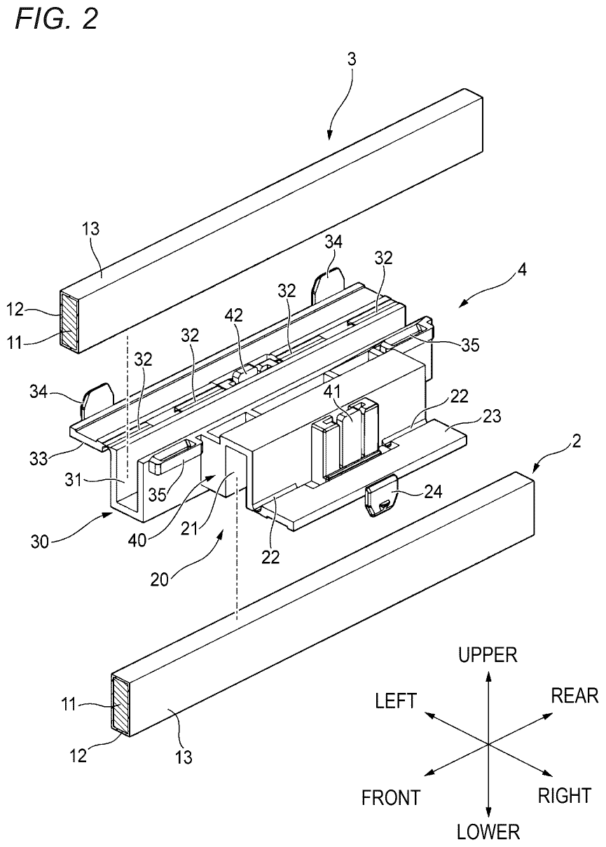

Hereinafter, a conductor 1 according to an embodiment of the present disclosure will be described with reference to the drawings. As shown in FIGS. 1 and 2 and the like, the conductor 1 includes a first bus bar 2, a second bus bar 3, and an exterior component 4 attached to attached portions 13, each of which is a part of each of the first bus bar 2 and the second bus bar 3 in an extending direction. In FIGS. 1 and 2 and the like, only the attached portions 13 are shown on the first bus bar 2 and the second bus bar 3. Typically, the conductor 1 is used by being mounted on an automobile or the like in a state in which the first bus bar 2 and the second bus bar 3 are routed in the automobile or the like, and the exterior component 4 attached to the attached portions 13 of the first bus bar 2 and the second bus bar 3 is fixed to a vehicle body or the like of the automobile or the like.

Hereinafter, for convenience of description, “front”, “rear”, “left”, “right”, “upper”, and “lower” are defined as shown in FIG. 1 or the like. A “front-rear direction”, a “left-right direction”, and an “upper-lower direction” are orthogonal to one another. The front-rear direction coincides with the extending direction of the attached portions 13 of the first bus bar 2 and the second bus bar 3 and an extending direction of the exterior component 4. These directions are merely defined for the convenience of description, and do not necessarily correspond to, for example, the front-rear direction, the left-right direction, and the upper-lower direction of the automobile or the like when the conductor 1 is mounted on the automobile or the like. Hereinafter, a configuration of each component constituting the conductor 1 will be described in order.

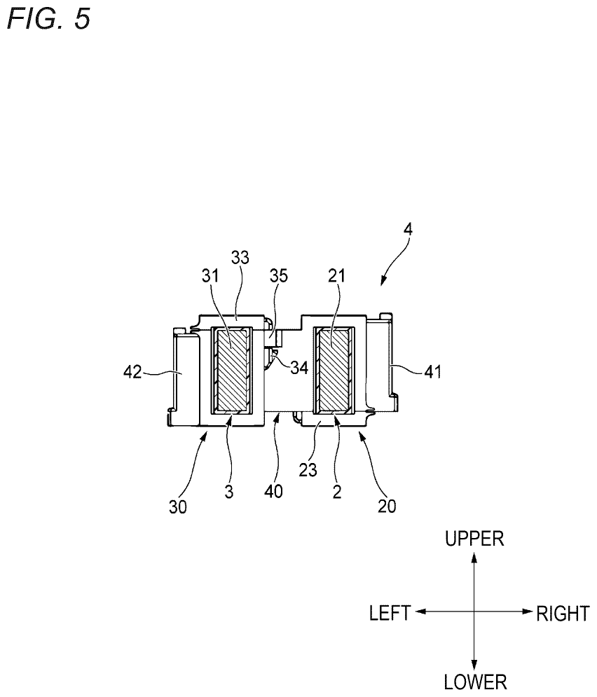

First, the first bus bar 2 and the second bus bar 3 will be described. The first bus bar 2 and the second bus bar 3 each have a shape (for example, a shape extending while being bent three-dimensionally) extending along a routing path according to the specifications of the automobile or the like, and includes a conductor portion 11 that extends in the above shape and an insulating sheath 12 with which an outer periphery of the conductor portion 11 is covered (see FIG. 2). In this example, a portion (conductor portion 11) shown in FIGS. 1 to 6, which is a part of each of the first bus bar 2 and the second bus bar 3, is a metal plate having a rectangular cross section and extending in an elongated shape, and the insulating sheath 12 covers the outer periphery of the conductor portion 11 over an entire region of the conductor portion 11 in the extending direction. A shape of a portion (not shown) of each of the first bus bar 2 and the second bus bar 3 may be determined based on the specifications or the like of the first bus bar 2 and the second bus bar 3, and may not necessarily have a linear shape.

As shown in FIGS. 1 to 4, each of the first bus bar 2 and the second bus bar 3 has, as the attached portion 13, a portion extending in a linear shape in the front-rear direction in a part in the extending direction (that is, conductor portion 11 covered with the insulating sheath 12 and extending in a linear shape). In this example, the entire region of the conductor portion 11 itself in the extending direction is covered with the insulating sheath 12, and thus it is not necessary to provide the exterior component 4 so as to cover the entire region of the first bus bar 2 and the second bus bar 3 in the extending direction. Therefore, in this example, the exterior component 4 is attached to the first bus bar 2 and the second bus bar 3 so as to cover (accommodate) only (a part or the whole in the extending direction of) the attached portions 13, which are a part of the first bus bar 2 and the second bus bar 3 in the extending direction. Accordingly, the exterior component 4 only needs to be capable of accommodating only (a part or the whole in the extending direction of) the attached portions 13 in a linear shape of the first bus bar 2 and the second bus bar 3, and does not need to have a dedicated shape for each bus bar, and thus has high versatility. On the other hand, in the first bus bar 2 and the second bus bar 3, a shape of a location other than the attached portions 13 can be designed without considering the presence of the exterior component 4. Accordingly, a degree of design freedom in the shapes of the first bus bar 2 and the second bus bar 3 is high.

Next, the exterior component 4 will be described. The exterior component 4 is a resin molded body, and generally includes a first block 20 extending in the front-rear direction, a second block 30 adjacent to a left side of the first block 20 and extending in the front-rear direction, and a coupling portion 40 that couples the first block 20 and the second block 30 to each other, as shown in FIGS. 2 to 6. In this example, a length of the second block 30 in the front-rear direction is larger than a length of the first block 20 in the front-rear direction, and both end portions of the second block 30 in the front-rear direction are positioned outside an extension range of the first block 20 in the front-rear direction.

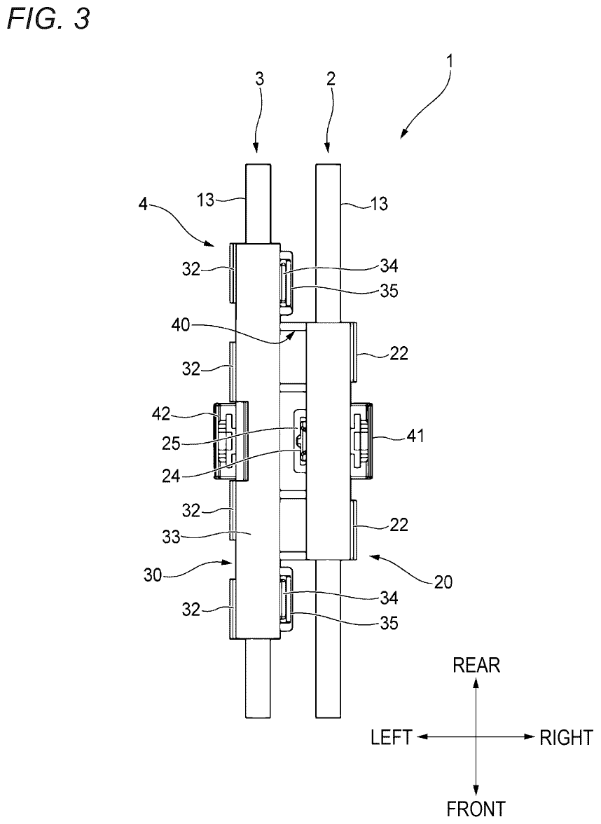

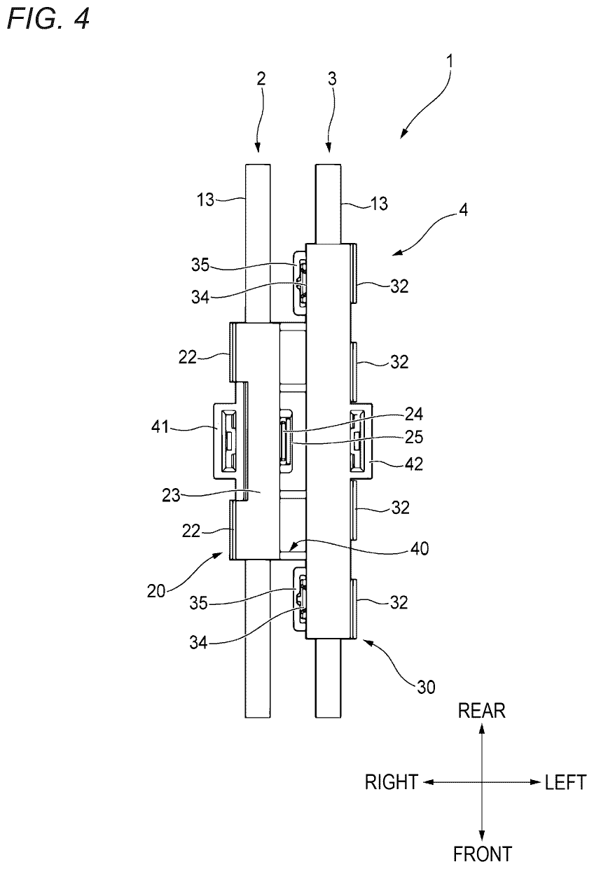

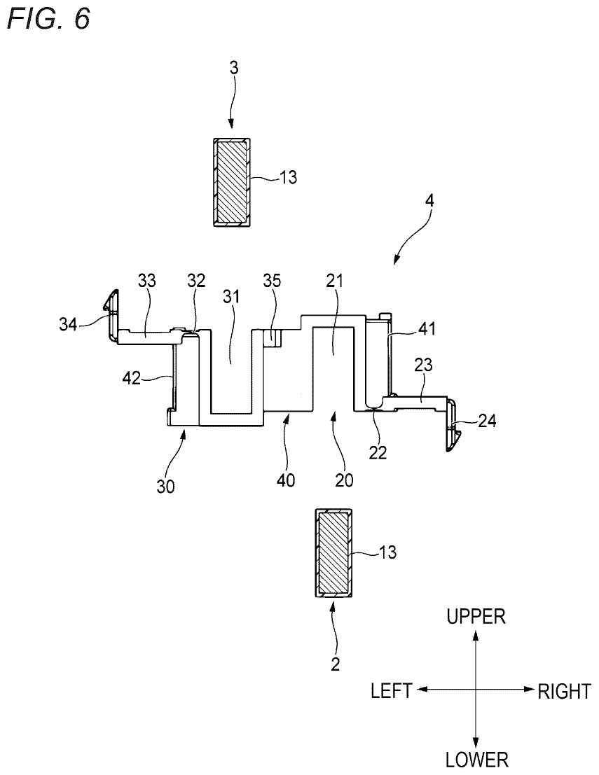

The first block 20 has a substantially U-shape opening downward as viewed in the front-rear direction, extends in a linear shape in the front-rear direction, and defines a first groove portion 21 opening downward and extending in a linear shape in the front-rear direction (see FIGS. 2 and 6 and the like). The first groove portion 21 accommodates the attached portion 13 of the first bus bar 2. A first cover portion 23 is coupled to a lower end portion of a right side wall of the first block 20 via a pair of front and rear hinge portions 22 so as to be capable of opening and closing an opening portion of the first groove portion 21. The first cover portion 23 has a substantially rectangular flat plate shape extending in the front-rear direction corresponding to a shape of the opening portion of the first groove portion 21. An engaging portion 24 is provided at a center portion in the front-rear direction of an end edge portion of the first cover portion 23, which extends in the front-rear direction on a side opposite to the pair of hinge portions 22. In a state in which the first cover portion 23 is closed (that is, in a state in which the opening portion of the first groove portion 21 is closed), the engaging portion 24 is engaged with an engaged portion 25 provided at a lower end portion of a left side wall of the first block 20 (see FIGS. 3 and 4). In this example, the engaging portion 24 is a locking piece having a locking protrusion, and the engaged portion 25 is a locking hole into which an engaging piece is inserted to lock the locking protrusion. A fixing portion 41 to be fixed to the vehicle body or the like of the automobile or the like is provided at a center portion in the front-rear direction of an outer face of the right side wall of the first block 20.

The second block 30 has a substantially U-shape opening upward as viewed in the front-rear direction, extends in a linear shape in the front-rear direction, and defines a second groove portion 31 opening upward and extending in a linear shape in the front-rear direction (see FIGS. 2 and 6 and the like). The second groove portion 31 accommodates the attached portion 13 of the second bus bar 3. A second cover portion 33 is coupled to an upper end portion of a left side wall of the second block 30 via a plurality of (four) hinge portions 32 arranged in the front-rear direction so as to be capable of opening and closing an opening portion of the second groove portion 31. The second cover portion 33 has a substantially rectangular flat plate shape extending in the front-rear direction corresponding to a shape of the opening portion of the second groove portion 31. A pair of front and rear engaging portions 34 are provided at both end portions in the front-rear direction of end edge portions of the second cover portion 33, which extend in the front-rear direction on sides opposite to the plurality of hinge portions 32. In a state in which the second cover portion 33 is closed (that is, in a state in which the opening portion of the second groove portion 31 is closed), the pair of engaging portions 34 are engaged with a pair of front and rear engaged portions 35 provided at upper end portions of a right side wall of the second block 30 (see FIGS. 3 to 5). In this example, the engaging portion 34 is a locking piece having a locking protrusion, and the engaged portion 35 is a locking hole into which an engaging piece is inserted to lock the locking protrusion. A fixing portion 42 to be fixed to the vehicle body or the like of the automobile or the like is provided at a center portion in the front-rear direction of an outer face of the left side wall of the second block 30. The configuration of each component constituting the conductor 1 has been described above.

Next, a procedure for attaching the exterior component 4 to the first bus bar 2 and the second bus bar 3 will be described. In order to attach the exterior component 4 to the first bus bar 2 and the second bus bar 3, first, as shown in FIG. 2, with respect to the exterior component 4 in which the first cover portion 23 and the second cover portion 33 are in an open state, the attached portion 13 which is a part of the first bus bar 2 in the extending direction is disposed below the first groove portion 21 that opens downward, and the attached portion 13 which is a part of the second bus bar 3 in the extending direction is disposed above the second groove portion 31 that opens upward. Next, the attached portion 13 of the first bus bar 2 is moved upward and accommodated in the first groove portion 21, and the first cover portion 23 is closed. The attached portion 13 of the second bus bar 3 is moved downward and accommodated in the second groove portion 31, and the second cover portion 33 is closed. Accordingly, the attachment of the exterior component 4 to the first bus bar 2 and the second bus bar 3 is completed, and the conductor 1 in the assembled state shown in FIG. 1 is obtained.

A work of attaching the exterior component 4 to the first bus bar 2 and a work of attaching the exterior component 4 to the second bus bar 3 may be performed in any order, or may be performed simultaneously. In the assembled state of the conductor 1, the first cover portion 23 is maintained in the closed state by the engagement of the engaging portion 24 and the engaged portion 25, and the second cover portion 33 is maintained in the closed state by the engagement of the engaging portions 34 and the engaged portions 35. The conductor 1 that has been assembled is mounted on the automobile or the like in a state in which the first bus bar 2 and the second bus bar 3 are routed in the automobile or the like and the pair of fixing portions 41, 42 (see FIG. 1 or the like) provided in the exterior component 4 attached to the attached portions 13 of the first bus bar 2 and the second bus bar 3 are fixed to the vehicle body or the like of the automobile or the like.

When the first bus bar 2 and the second bus bar 3 are detached from the exterior component 4 in the conductor 1 that has been assembled, first, the closed first cover portion 23 and second cover portion 33 are opened. Next, the attached portion 13 of the first bus bar 2 is moved downward toward the outside of the first groove portion 21 through the opening portion that opens downward of the first groove portion 21, and the attached portion 13 of the second bus bar 3 is moved upward toward the outside of the second groove portion 31 through the opening portion that opens upward of the second groove portion 31. Accordingly, the work of detaching the first bus bar 2 and the second bus bar 3 from the exterior component 4 is completed.

The work of detaching the first bus bar 2 from the exterior component 4 and the work of detaching the second bus bar 3 from the exterior component 4 may be performed in any order, or may be performed simultaneously. In this example, the first groove portion 21 and the second groove portion 31 open in mutually different directions (downward and upward), and thus when the first bus bar 2 and the second bus bar 3 are detached from the exterior component 4, one of the bus bars is prevented from coming into contact with the other of the bus bars, thereby preventing an unintended short circuit between the bus bars. Further, the first cover portion 23 and the second cover portion 33 can be opened and closed independently of each other as necessary. Accordingly, a degree of freedom in attaching and detaching the exterior component 4 to and from the first bus bar 2 and the second bus bar 3 can be improved.

### <Operation and Effect>

According to the conductor 1 according to the present embodiment, the first bus bar 2 and the second bus bar 3 each include the conductor portion 11 covered with the insulating sheath 12, and at least partially includes the attached portion 13 extending in a linear shape. The attached portions 13 are used to attach the first bus bar 2 and the second bus bar 3 and the exterior component 4. Specifically, the attached portions 13 of the first bus bar 2 and the second bus bar 3 are accommodated in the first groove portion 21 and the second groove portion 31 of the exterior component 4, respectively. In this way, the conductor portion 11 of each of the first bus bar 2 and the second bus bar 3 is covered with the insulating sheath 12, and thus it is not necessary to provide the exterior component 4 so as to cover the entire first bus bar 2 and second bus bar 3. Further, the exterior component 4 only needs to have the first groove portion 21 and the second groove portion 31 capable of accommodating the attached portions 13 in a linear shape, and the first cover portion 23 and the second cover portion 33 for opening and closing the first groove portion 21 and the second groove portion 31, and does not need to have a dedicated shape for each bus bar. Accordingly, the versatility of the exterior component 4 can be improved. On the other hand, in the first bus bar 2 and the second bus bar 3, a shape of a location other than the attached portions 13 can be designed without considering the presence of the exterior component 4. Accordingly, the degree of design freedom in the shapes of the first bus bar 2 and the second bus bar 3 can be improved. Therefore, the conductor 1 can achieve both the improvement of the degree of design freedom in the shapes of the first bus bar 2 and the second bus bar 3 and the improvement of the versatility of the exterior component 4.

Further, as another effect, the first groove portion 21 and the second groove portion 31 of the exterior component 4 open in the mutually different directions, and thus when the first bus bar 2 and the second bus bar 3 are detached from the exterior component 4, one of the first bus bar 2 and the second bus bar 3 is prevented from coming into contact with the other of the bus bars, thereby preventing an unintended short circuit between the first bus bar 2 and the second bus bar 3. Further, it is possible to reduce a size of the exterior component 4 or to improve a workability of the work of attaching the exterior component 4 to the first bus bar 2 and the second bus bar 3.

Further, the first cover portion 23 is coupled to the first block 20 of the exterior component 4 so as to be displaceable in a hinge shape, and when the opening portion of the first groove portion 21 in the first block 20 is closed by the first cover portion 23, the engaging portion 24 of the first cover portion 23 is engaged with the engaged portion 25 provided in the first block 20. In contrast, the second cover portion 33 is coupled to the second block 30 of the exterior component 4 so as to be displaceable in a hinge shape, and when the opening portion of the second groove portion 31 in the second block 30 is closed by the second cover portion 33, the engaging portions 34 of the second cover portion 33 are engaged with the engaged portions 35 provided in the second block 30. Accordingly, the first cover portion 23 and the second cover portion 33 can be opened and closed independently of each other as necessary. Accordingly, the degree of freedom in attaching and detaching the exterior component 4 to and from the first bus bar 2 and the second bus bar 3 can be improved.

### OTHER EMBODIMENTS

The present disclosure is not limited to the embodiment described above, and various modifications can be adopted within the scope of the present disclosure. For example, the present disclosure is not limited to the embodiment described above, and modifications, improvements, and the like can be appropriately made. In addition, materials, shapes, sizes, numbers, arrangement positions, and the like of components in the embodiment described above are freely selected and are not limited as long as the present disclosure can be implemented.

In the above embodiment, in a state in which the first cover portion 23 coupled to the first block 20 via the hinge portion 22 is closed, the engaging portion 24 provided at the end edge portion of the first cover portion 23 on the side opposite to the hinge portion 22 is engaged with the engaged portion 25 provided at the lower end portion of the left side wall of the first block 20, and in a state in which the second cover portion 33 coupled to the second block 30 via the hinge portions 32 is closed, the engaging portions 34 provided at the end edge portions of the second cover portion 33 on the side opposite to the hinge portions 32 are engaged with the engaged portions 35 provided at the upper end portions of the right side wall of the second block 30 (see FIGS. 3, 4, and 6).

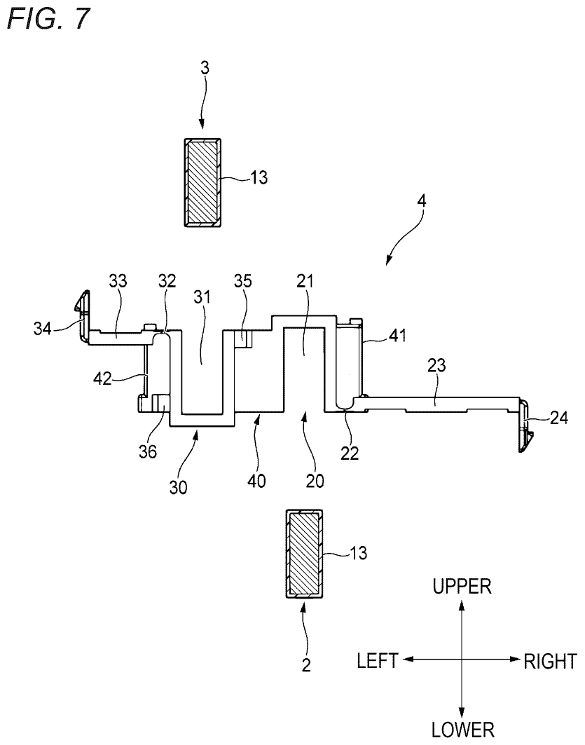

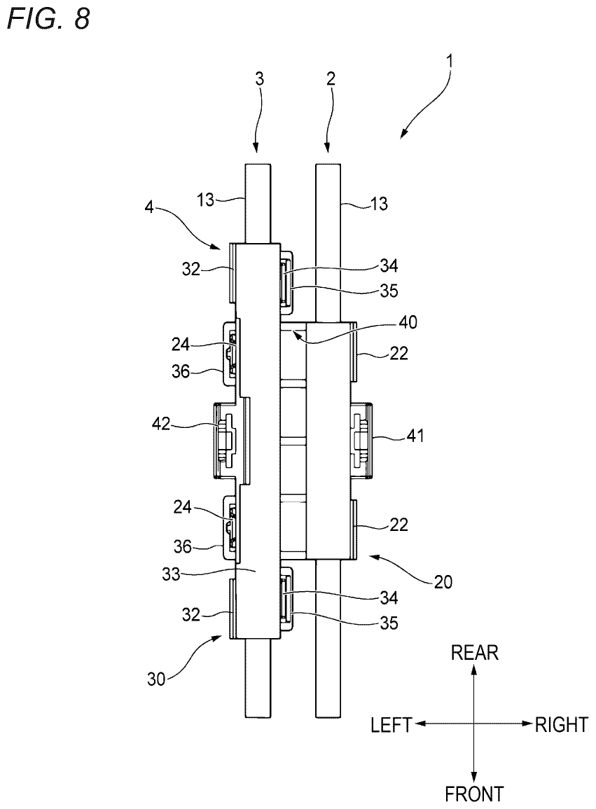

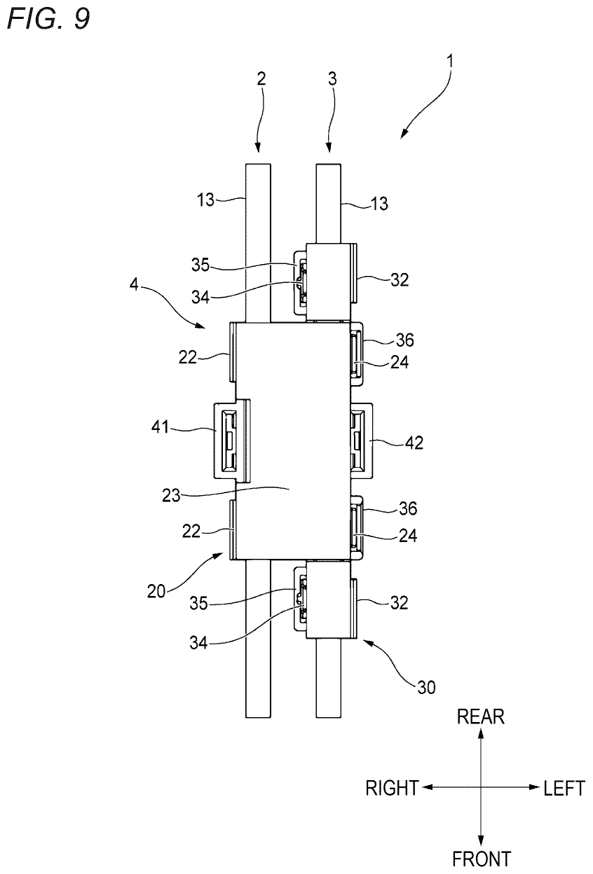

In contrast, in the modification shown in FIGS. 7 to 9, a length in the left-right direction is increased in the closed state of the first cover portion 23, and an engaged portion 36 is provided at a lower end portion of the left side wall of the second block 30 instead of the engaged portion 25 provided at the lower end portion of the left side wall of the first block 20 in the above embodiment (particularly, see FIG. 7).

In the modification shown in FIGS. 7 to 9, in the state in which the first cover portion 23 coupled to the first block 20 via the hinge portions 22 is closed, the engaging portions 24 provided at the end edge portions of the first cover portion 23 on the sides opposite to the hinge portions 22 are engaged with the engaged portions 36 provided at the lower end portions of the left side wall of the second block 30, and in the state in which the second cover portion 33 coupled to the second block 30 via the hinge portions 32 is closed, the engaging portions 34 provided at the end edge portions of the second cover portion 33 on the sides opposite to the hinge portions 32 are engaged with the engaged portions 35 provided at the upper end portions of the right side wall of the second block 30. That is, the second block 30 is collectively provided with both the engaged portions 36 that are engaged with the engaging portions 24 of the first cover portion 23 and the engaged portions 35 that are engaged with the engaging portions 34 of the second cover portion 33. Accordingly, a workability of a work of opening and closing the first cover portion 23 and the second cover portion 33 is improved as compared with the above embodiment in which the engaged portion 25 engaged with the engaging portion 24 of the first cover portion 23 and the engaged portions 35 engaged with the engaging portions 34 of the second cover portion 33 are provided in different blocks.

Further, as another modification similar to the above modification, a length in the left-right direction is increased in the closed state of the second cover portion 33, and a new engaged portion may be provided at the upper end portion of the right side wall of the first block 20 instead of the engaged portions 35 in the above embodiment provided at the upper end portions of the right side wall of the second block 30. Accordingly, the first block 20 is collectively provided with the engaged portion 25 that is engaged with the engaging portion 24 of the first cover portion 23 and the new engaged portion that is engaged with the engaging portion 34 of the second cover portion 33, and thus the workability of the work of opening and closing the first cover portion 23 and the second cover portion 33 is improved as in the above modification.

Here, features of the embodiment of the conductor 1 according to the present disclosure described above are briefly summarized and listed in the following [1] to [3].

(i)

A conductor (1) comprising:
a pair of bus bars (2, 3); and
an exterior component (4) attached to the pair of bus bars (2, 3), in which
each of the pair of bus bars (2, 3) includes a conductor portion (11) and an insulating sheath (12) with which the conductor portion (11) is covered, and at least partially includes an attached portion (13) extending in a linear shape, and
the exterior component (4) includes a pair of groove portions (21, 31) extending in a linear shape so as to be capable of accommodating the attached portions (13) of the pair of bus bars (2, 3) and opening in mutually different directions, and a pair of cover portions (23, 33) capable of opening and closing opening portions of the pair of groove portions (21, 31).

According to the conductor of the configuration of the above (i), each of the pair of bus bars includes the conductor portion covered with the insulating sheath, and at least partially includes the attached portion extending in a linear shape. The attached portion is used to attach the bus bar and the exterior component. Specifically, the attached portions of the pair of bus bars are accommodated in the pair of groove portions of the exterior component, respectively. In this way, the conductor portion of the bus bar is covered with the insulating sheath, and thus it is not necessary to provide the exterior component so as to cover the entire bus bars. Further, the exterior component only needs to have the groove portions capable of accommodating the attached portions in a linear shape and the cover portions for opening and closing the groove portions, and does not need to have a dedicated shape for each bus bar. Accordingly, versatility of the exterior component can be improved. On the other hand, in the bus bar, a shape of a location other than the attached portions can be designed without considering the presence of the exterior component. Accordingly, a degree of design freedom in the shapes of the bus bars can be improved. Therefore, the conductor of the present configuration can achieve both the improvement of the degree of design freedom in the shapes of the bus bars and the improvement of the versatility of the exterior component.

Further, as another effect, the pair of groove portions of the exterior component open in the mutually different directions, and thus when the bus bars are detached from the exterior component, one of the bus bars is prevented from coming into contact with the other of the bus bars, thereby preventing an unintended short circuit between the bus bars. Further, it is possible to reduce a size of the exterior component or to improve a workability of a work of attaching the exterior component to the bus bar.

(ii)

The conductor (1) according to the above (i), in which
the exterior component (4) includes a first block (20) that constitutes one of the pair of groove portions (21) and a second block (30) that constitutes the other of the pair of groove portions (31),
one of the pair of cover portions (23) is coupled to the first block (20) so as to be displaceable in a hinge shape, and is engaged with an engaged portion (25) provided in the first block (20) when the opening portion of the one of the groove portions (21) is closed, and
the other of the pair of cover portions (33) is coupled to the second block (30) so as to be displaceable in a hinge shape, and is engaged with an engaged portion (35) provided in the second block (30) when the opening portion of the other of the groove portions (31) is closed.

According to the conductor of the configuration of the above (ii), the one of the cover portions is coupled to the first block of the exterior component so as to be displaceable in a hinge shape. Further, when the opening portion of the groove portion in the first block is closed by the cover portion (one of the cover portions), the cover portion is engaged with the engaged portion provided in the first block. In contrast, the other of the cover portions is coupled to the second block of the exterior component so as to be displaceable in a hinge shape. Further, when the opening portion of the groove portion in the second block is closed by the cover portion (the other of the cover portions), the cover portion is engaged with the engaged portion provided in the second block. In this way, the pair of cover portions can be opened and closed independently of each other as necessary. Accordingly, a degree of freedom in attaching and detaching the exterior component to and from the pair of bus bars can be improved.

(iii)

The conductor (1) according to the above (i), in which
the exterior component (4) includes a first block (20) that constitutes one of the pair of groove portions (21) and a second block (30) that constitutes the other of the pair of groove portions (31),
one of the pair of cover portions (23) is coupled to the first block (20) so as to be displaceable in a hinge shape, and is engaged with an engaged portion (36) provided in the second block (30) when the opening portion of the one of the groove portions (21) is closed, and
the other of the pair of cover portions (33) is coupled to the second block (30) so as to be displaceable in a hinge shape, and is engaged with an engaged portion (35) provided in the second block (30) when the opening portion of the other of the groove portions (31) is closed.

According to the conductor of the configuration of the above (iii), the one of the cover portions is coupled to the first block of the exterior component so as to be displaceable in a hinge shape. Further, when the opening portion of the groove portion in the first block is closed by the cover portion (one of the cover portions), the cover portion is engaged with the engaged portion provided in the second block. In contrast, the other of the cover portions is coupled to the second block of the exterior component so as to be displaceable in a hinge shape. Further, when the opening portion of the groove portion in the second block is closed by the cover portion (the other of the cover portions), the cover portion is engaged with the engaged portion provided in the second block. In this way, the pair of cover portions can be opened and closed independently of each other as necessary. Further, the second block is collectively provided with both the engaged portion that engages with one of the cover portions and the engaged portion that engages with the other of the cover portions. Therefore, a workability of a work of opening and closing the pair of cover portions is improved as compared with a case in which the engaged portions are distributed and arranged in the plurality of blocks. Accordingly, the degree of freedom in attaching and detaching the exterior component to and from the pair of bus bars can be improved.

What is claimed is:

1. A conductor comprising:
a pair of bus bars; and
an exterior component attached to the pair of bus bars, wherein
each of the pair of bus bars includes a conductor portion and an insulating sheath with which the conductor portion is covered, and at least partially includes an attached portion extending in a linear shape, and
the exterior component includes a pair of groove portions extending in a linear shape so as to be capable of accommodating the attached portions of the pair of bus bars and opening in mutually different directions, and a pair of cover portions capable of opening and closing opening portions of the pair of groove portions.

2. The conductor according to claim 1, wherein
the exterior component includes a first block that constitutes one of the pair of groove portions and a second block that constitutes the other of the pair of groove portions,
one of the pair of cover portions is coupled to the first block so as to be displaceable in a hinge shape, and is engaged with an engaged portion provided in the first block when the opening portion of the one of the groove portions is closed, and
the other of the pair of cover portions is coupled to the second block so as to be displaceable in a hinge shape, and is engaged with an engaged portion provided in the second block when the opening portion of the other of the groove portions is closed.

3. The conductor according to claim 1, wherein
the exterior component includes a first block that constitutes one of the pair of groove portions and a second block that constitutes the other of the pair of groove portions,
one of the pair of cover portions is coupled to the first block so as to be displaceable in a hinge shape, and is engaged with an engaged portion provided in the second block when the opening portion of the one of the groove portions is closed, and
the other of the pair of cover portions is coupled to the second block so as to be displaceable in a hinge shape, and is engaged with an engaged portion provided in the second block when the opening portion of the other of the groove portions is closed.
